(19) United States
(12) Patent Application Publication
(10) Pub. No.: US 2012/0188526 A1
(43) Pub. Date: Jul. 26, 2012

(54) ILLUMINATION OPTICAL APPARATUS, EXPOSURE APPARATUS, AND DEVICE MANUFACTURING METHOD

(76) Inventors: Tetsuya Oshino, Yamato City (JP); Yoshio Kawabe, Kumogaya-City (JP)

(21) Appl. No.: 13/498,810

(22) PCT Filed: Sep. 29, 2010
(86) PCT No.: PCT/JP2010/066987

§ 371 Date: Mar. 28, 2012

(30) Foreign Application Priority Data
Sep. 29, 2009 (JP) 2009-224710

(51) Int. Cl. G03B 27/54

(52) U.S. Cl. 355/67

(57) ABSTRACT

An illumination optical apparatus includes an integrator optical device that includes a first element group (230A) prescribing a first illumination condition and a second element group (230B) prescribing a second illumination condition other than the first illumination condition and an irradiation device (40) that selectively directs light to the first element group or the second element group.

### TECHNICAL FIELD

The present invention relates to an illumination optical apparatus, an exposure apparatus, and a device manufacturing method.

Priority is claimed on Japanese Patent Application No. 2009-224710, filed Sep. 29, 2009, the contents of which are incorporated herein by reference.

### BACKGROUND ART

In the photolithography process provided as one of processes of manufacturing micro-devices such as a semiconductor device, a liquid crystal display device, an imaging device, a liquid crystal display device, and a thin-film magnetic head, an exposure apparatus projecting a pattern formed on a mask or a reticle (hereinafter, generically termed a mask) onto a wafer to be exposed is used (for example, see Patent Document 1). Some of such exposure apparatuses have an illumination optical apparatus causing exposure light emitted from a light source to be incident on a fly-eye lens and forming a secondary light source including plural light source images.

Patterns formed on masks have been miniaturized and it is necessary to set plural illumination conditions depending on the types of the fine patterns. In the illumination optical apparatuses in the background art, the size or shape of the aperture of an aperture diaphragm is changed to change illumination conditions such as a coherence factor σ (σ=emission-side aperture number of illumination optical system/incidence-side aperture number of projection optical system) of a normal illumination and the shapes (such as a dipolar shape, a tetrapolar shape, and an orbicular-zone shape) of a modified illumination.

### PRIOR ART DOCUMENTS

### Patent Document

[Patent Document 1] Japanese Unexamined Patent Application, First Publication No. 2002-231619

### SUMMARY OF INVENTION

### Problems to be Solved by the Invention

However, there is a problem in that the light intensity is markedly lost by changing the size or shape of the aperture of the aperture diaphragm.

An object of some aspects of the invention is to provide an illumination optical apparatus, an exposure apparatus, and a device manufacturing method, which can suppress the loss in intensity of illumination light due to a change in illumination conditions.

### Means for Solving the Problems

According to an aspect of the invention, there is provided an illumination optical apparatus including: an integrator optical device that includes a first element group prescribing a first illumination condition and a second element group prescribing a second illumination condition other than the first illumination condition; and an irradiation device that selectively directs light to the first element group or the second element group.

According to another aspect of the invention, there is provided an exposure apparatus including: the illumination optical apparatus that illuminates a mask having a pattern, formed thereon; and a projection optical system that projects a pattern image of the mask illuminated by the illumination optical apparatus onto a wafer.

According to still another aspect of the invention, there is provided a device manufacturing method using the exposure apparatus.

### Advantage of the Invention

According to the aspects of the invention, it is possible to suppress the loss in intensity of illumination light due to a change in illumination conditions.

### BRIEF DESCRIPTION OF THE DRAWINGS

FIG. 1 is a diagram illustrating the configuration of an exposure apparatus according to a first embodiment of the invention.

FIG. 2 is a diagram illustrating the configuration of an optical integrator of an illumination optical apparatus according to the first embodiment of the invention.

FIG. 3 is a plan view illustrating a second reflective integrator according to the first embodiment of the invention.

FIG. 4 is a cross-sectional view illustrating elements of a first reflective integrator according to the first embodiment of the invention.

FIG. 5 is a diagram illustrating the optical integrator of the illumination optical apparatus according to the first embodiment of the invention in a case of a dipolar illumination.

FIG. 6 is a diagram illustrating the optical integrator of the illumination optical apparatus according to the first embodiment of the invention in a case of a tetrapolar illumination.

FIG. 7 is a plan view illustrating a second reflective integrator according to the first embodiment of the invention in a case of a normal illumination.

FIG. 8 is a plan view illustrating the second reflective integrator according to the first embodiment of the invention in a case of a bipolar illumination.

FIG. 9 is a plan view illustrating the second reflective integrator according to the first embodiment of the invention in a case of a tetrapolar illumination.

FIG. 10 is a cross-sectional view illustrating a driving example of elements of the first reflective integrator according to the first embodiment of the invention.

FIG. 11 is a diagram illustrating the configuration of an optical integrator 4 of an illumination optical apparatus according to a second embodiment of the invention.

FIG. 12 is a plan view illustrating a first reflective integrator according to the second embodiment of the invention.

FIG. 13 is a plan view illustrating a second reflective integrator according to a third embodiment of the invention.

FIG. 14 is a diagram schematically illustrating the second reflective integrator according to the third embodiment of the invention.

FIG. 15 is a plan view illustrating the second reflective integrator according to the third embodiment of the invention in a case of a normal illumination.

FIG. 16 is a plan view illustrating the second reflective integrator according to the third embodiment of the invention in a case of a normal illumination.

FIG. 17 is a plan view illustrating the second reflective integrator according to the third embodiment of the invention in a case of a bipolar illumination.

FIG. 18 is a plan view illustrating the second reflective integrator according to the third embodiment of the invention in a case of a tetrapolar illumination.

FIG. 19 is a plan view illustrating the second reflective integrator according to the third embodiment of the invention in a case of an orbicular-zone illumination.

FIG. 20 is a plan view illustrating the second reflective integrator according to the third embodiment of the invention in a case of an orbicular-zone illumination.

FIG. 21 is a plan view illustrating a part of an illumination device according to a fourth embodiment of the invention.

FIG. 22 is a diagram illustrating the configuration of an optical integrator of an illumination optical apparatus according to the fourth embodiment of the invention.

FIG. 23 is a flowchart illustrating an example of a micro-device manufacturing process.

### DESCRIPTION OF EMBODIMENTS

### First Embodiment

Hereinafter, a first embodiment of the invention will be described with reference to the accompanying drawings.

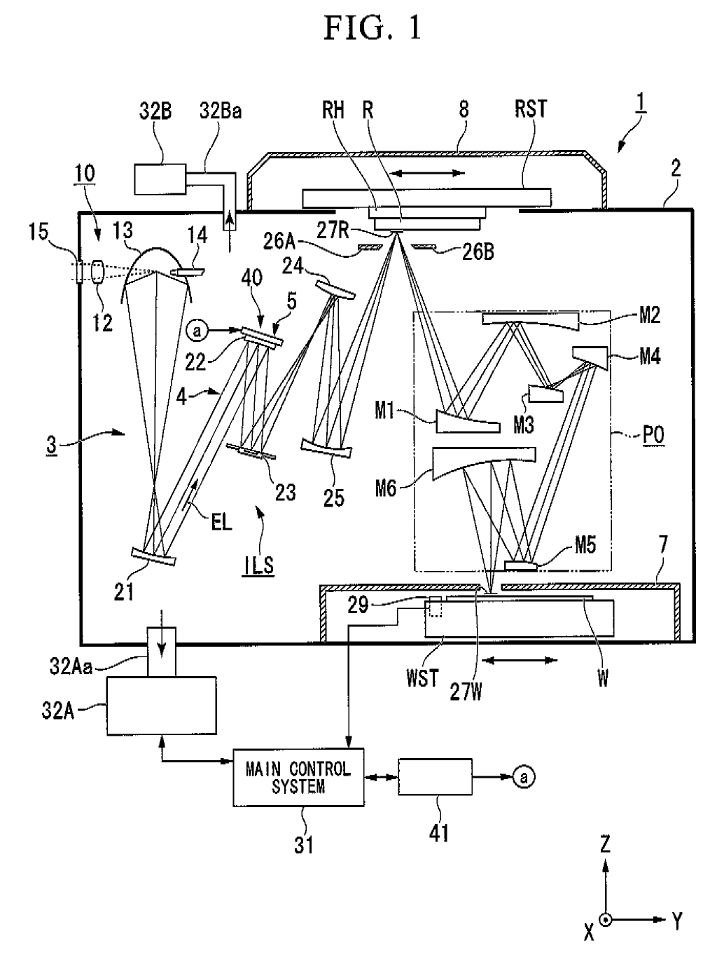

FIG. 1 is a cross-sectional view schematically illustrating the entire configuration of an exposure apparatus (EUV exposure apparatus) 1 according to this embodiment. In this embodiment, the exposure apparatus (EUV exposure apparatus) 1 uses EUV light (Extreme Ultraviolet Light) with a wavelength equal to or less than 100 nm, for example, in the range of about 3 to 50 nm such as 11 nm or 13 nm, as exposure light EL (illumination light).

In FIG. 1, the exposure apparatus 1 includes an illumination optical apparatus 3 including a laser plasma light source 10 emitting exposure light EL and an illumination optical system ILS illuminating a reticle (mask) R with the exposure light EL, a reticle stage RST that moves while holding the reticle R, and a projection optical system PO projecting the image of a pattern formed on a pattern surface (reticle plane) of the reticle R onto a wafer W (photosensitive substrate) W coated with a resist (photosensitive material). The exposure apparatus 1 further includes a wafer stage WT holding and moving the wafer W and a main control system 31 and the like including a computer intensively controlling the entire operation of the apparatus.

In this embodiment, since the EUV light is used as the exposure light EL, the illumination optical system ILS and the projection optical system PO include plural mirrors except for a specific filter (not shown) and the like and the reticle R is reflective. A multi-layered reflection film reflecting the EUV light is formed on the reflection planes of the mirrors and the reticle plane. A circuit pattern is formed on the reflection film on the reticle plane out of an absorption layer. In order to prevent the exposure light EL from being absorbed by gas, the exposure apparatus 1 is provided with such as large-capacity vacuum pumps 32A and 32B of which almost the entire part is received in a box-like vacuum chamber 2 and which exhaust the space in the vacuum chamber 2 through such as exhaust pipes 32Aa and 32Ba. In order to enhance the degree of vacuum in the optical path of the exposure light EL in the vacuum chamber 2, plural sub chambers (not shown) are provided. For example, the pressure in the vacuum chamber 2 is about 10⁻⁵ Pa and the pressure in the sub chamber (not shown) receiving the projection optical system PO in the vacuum chamber 2 is in the range of about 10⁻⁵ to 10⁻⁶ Pa.

In FIG. 1, the Z axis is taken as the normal direction of the surface (the bottom surface of the vacuum chamber 2) on which the wafer stage WST is placed, the X axis is taken as the direction perpendicular to the drawing surface of FIG. 1 in the plane perpendicular to the Z axis, and the Y axis is taken as the direction parallel to the drawing surface of FIG. 1. In this embodiment, an illumination area 27R of the exposure light EL on the reticle plane has an arc-like shape thin and long in the X direction. At the time of exposure, the reticle R and the wafer W are synchronously scanned in the Y direction (scanning direction) relative to the projection optical system PO.

The laser plasma light source 10 is a gas-jet cluster type light source including a high-power laser light source (not shown), a condenser lens 12 condensing a laser beam supplied form the laser light source via a window member 15 of the vacuum chamber 2, a nozzle 14 ejecting target gas such as xenon or krypton, and a condenser mirror 13 having a reflection surface like an ellipsoid of revolution. The exposure light EL emitted from the laser plasma light source 10 is condensed on a second focus of the condenser mirror 13. The exposure light EL condensed on the second focus is changed to a parallel light beam through the use of a concave mirror 21 and is guided to an optical integrator (fly-eye optical system) 4 including a pair of reflective integrators (reflective optical members) 22 and 23 uniformizing the illuminance distribution of the exposure light EL. The basic configuration and operation of the fly-eye optical system are disclosed, for example, in U.S. Pat. No. 6,452,661.

The exposure light EL passing through the optical integrator 4 is once condensed and then is incident on a curved mirror 24. The exposure light EL reflected by the curved mirror 24 is reflected by a concave mirror 25, an end portion of the exposure light in the −Y direction is shielded by an arc-like edge portion of a blind plate 26A, and the resultant light illuminates the pattern surface of the reticle R from the downside with the arc-like illumination area 27R. The arc-like illumination area 27R illuminating the pattern surface of the reticle R has a uniform illuminance distribution. The curved mirror 24 and the concave mirror 25 constitute a condenser optical system. The reticle plane is illuminated in a superimposed manner with light from an element group (reflective mirror element group) constituting the reflective integrator 23 by the condenser optical system. In the example shown in FIG. 1, the curved mirror 24 is a convex mirror. Alternatively, a configuration in which a concave mirror instead of the convex mirror is used as the curved mirror 24 and the curvature of the concave mirror 25 is relatively small may be employed. The concave mirror 21, the optical integrator 4, the curved mirror 24, and the concave mirror 25 constitute the illumination optical system ILS. The configuration of the illumination optical system ILS is not fixed and for example, a mirror may be interposed between the concave mirror 25 and the reticle R so as to, for example, further reduce an incidence angle of the exposure light EL on the reticle plane.

The exposure light EL reflected by the illumination region 27R of the reticle R is incident on the projection optical system PO after an end portion of the exposure light in the +Y direction is shielded by the arc-like edge of the blind plate 26B. The exposure light EL passing through the projection optical system PO is projected to an exposure area (an area conjugate to the illumination area 27R) 27W on the wafer W. The blind plates 26A and 26B may be disposed, for example, in the vicinity of the plane in the illumination optical system ILS conjugate to the reticle plane.

The reticle R is suctioned and held on the bottom surface of the reticle stage RST by the use of an electrostatic chuck RH. By a driving system (not shown) including, for example, a magnetic levitation type two-dimensional linear actuator, the reticle stage RST is driven in the Y direction with a predetermined stroke along a guide plane parallel to the XY plane of the outer surface of the vacuum chamber 2 on the basis of a measured value of a laser interferometer (not shown) and control information from the main control system 31 and is also minutely driven in the X direction and the θz direction (the rotation direction about the Z axis). A partition 8 is disposed to cover the reticle stage RST toward the vacuum chamber 2. The inside of the partition 8 is maintained at an intermediate pressure between the atmospheric pressure and the pressure in the vacuum chamber 2 by the use of a vacuum pump which is not shown.

An optical reticle auto-focusing system (not shown) obliquely applying, for example, measurement light to the reticle plane and measuring the position in the Z direction (Z position) of the reticle plane is disposed on the pattern surface side of the reticle R. The main control system 31 sets the Z position of the reticle R in an allowable range by the use of a Z driving mechanism (not shown) in the reticle stage RST on the basis of the value measured by the reticle auto-focusing system during the scanning exposure.

The projection optical system PO has for example, a configuration in which six mirrors M1 to M6 are held by a barrel which is not shown. The projection optical system PO is a reflection system which is non-telecentric on an object (reticle R) side and is telecentric on an image (wafer W) side, and the projection magnification thereof is a reduction magnification of ¼ times or the like. The exposure light EL reflected by the illumination area 27R of the reticle R forms a reduced image of a partial pattern of the reticle R in an exposure area 27W on the wafer W through the projection optical system PO.

In the projection optical system PO, the exposure light EL from the reticle R is reflected upward (in the +Z direction) by the mirror M1, is then reflected downward by the mirror M2, is reflected upward by the mirror M3, and is then reflected downward by the mirror M4. Then, the exposure light EL reflected upward by the mirror M5 is reflected downward by the mirror M6 and forms a partial image of the pattern of the reticle R on the wafer W. For example, the mirrors M1, M2, M3, M4, and M6 are concave mirrors and the other mirror M5 is a convex mirror.

On the other hand, the wafer W is suctioned and held on the wafer stage WST by the use of an electrostatic chuck (not shown). The wafer stage WST is disposed on the guide plane parallel to the XY plane. The wafer stage WST is driven in the X direction and the Y direction with a predetermined stroke by the use of a driving system (not shown) including, for example, a magnetic levitation type two-dimensional linear actuator on the basis of a measured value of a laser interferometer (not shown) and control information from the main control system 31, and if necessary, the wafer stage WST is also driven in the θz direction.

For example, an aerial image measuring system 29 detecting an image of an alignment mark of the reticle R is disposed in the vicinity of the wafer W on the wafer stage WST and the detection result of the aerial image measuring system 29 is supplied to the main control system 31. The main control system 31 can acquire optical characteristics (aberrations or wavefront aberration) of the projection optical system PO from the detection result of the aerial image measuring system 29. The optical characteristics may be acquired through the use of test printing or the like.

The wafer W is disposed inside a partition 7 so that gas generated from the resist on the wafer W does not have an adverse influence on the mirrors M1 to M6 of the projection optical system PO during the exposure. An opening passing the exposure light EL is formed in the partition 7. The space in the partition 7 is exhausted to a vacuum by a vacuum pump (not shown).

When a shot area (die) on the wafer W is exposed, the exposure light EL illuminates the pattern surface of the reticle R with the arc-like illumination area 27R through the illumination optical system ILS, and the reticle R and the wafer W synchronously move in the Y direction at a predetermined speed ratio based on the reduction magnification of the projection optical system PO relative to the projection optical system PO (synchronous scanning). In this way, one shot area on the wafer W is exposed to the reticle pattern. Thereafter, the wafer stage WST is driven to move the wafer W step by step and then the next shot area on the wafer W is scanned and exposed to the pattern of the reticle R. In this way, plural shot areas on the wafer W are sequentially exposed to the image of the pattern of the reticle R in a step-and-scan manner.

The characteristic configuration of the optical integrator 4 in the illumination optical apparatus 3 according to this embodiment will be described below.

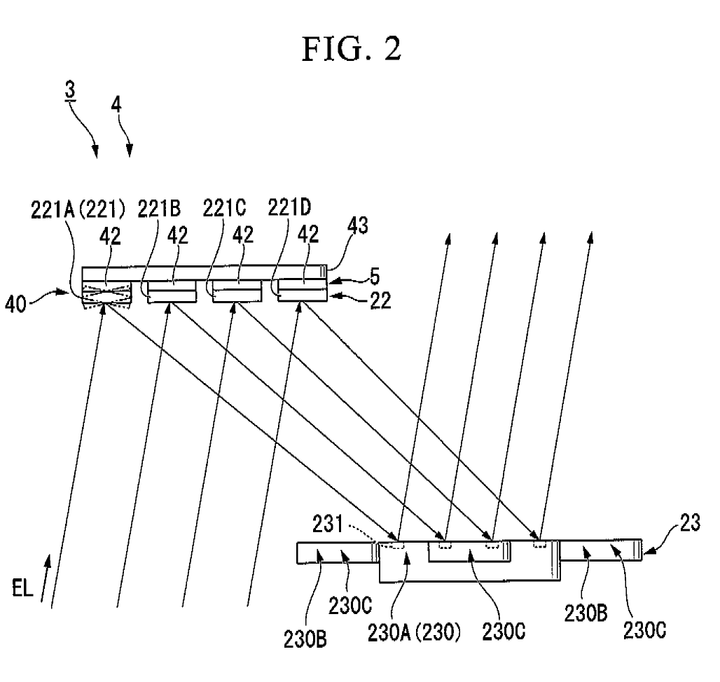

FIG. 2 is a diagram illustrating the configuration of the optical integrator 4 of the illumination optical apparatus 3 according to the first embodiment of the invention. The optical integrator 4 includes a reflective integrator 22 located at a position optically conjugate to the reticle R as an illuminated plane or in the vicinity of the conjugate position and a reflective integrator 23 located at a position optically conjugate to the pupil of the projection optical system PO or in the vicinity of the conjugate position. In the following description, the reflective integrator 22 is also referred to as a first reflective integrator (reflective optical device) 22 and the reflective integrator 23 is also referred to as a second reflective integrator (reflective optical device) 23.

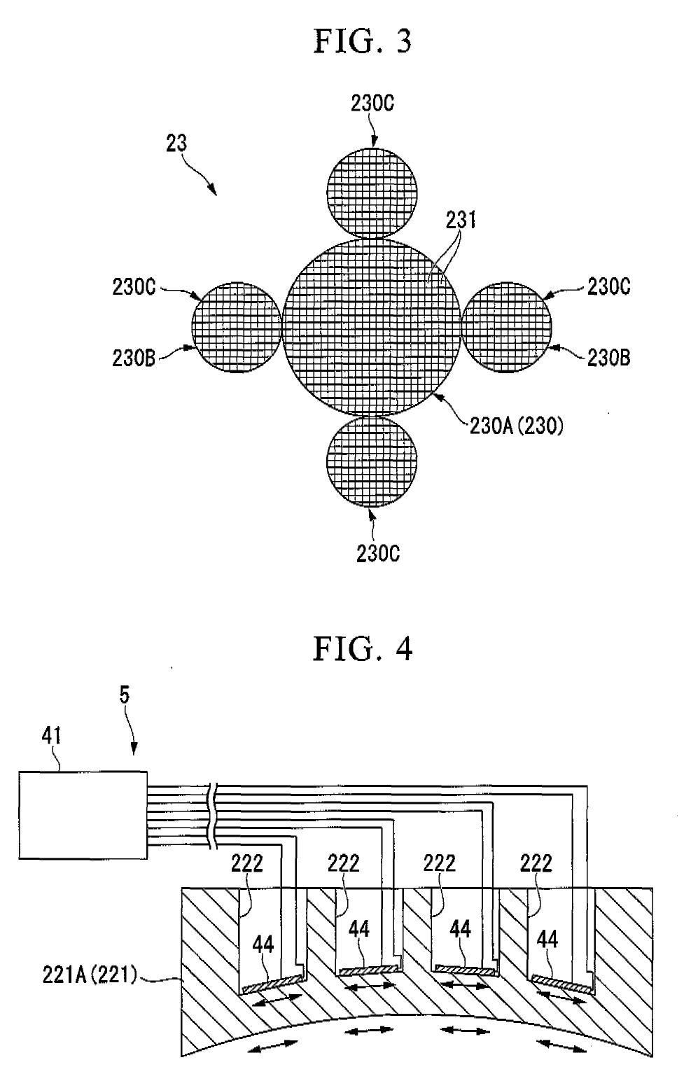

FIG. 3 is a plan view illustrating the second reflective integrator 23 in the first embodiment of the invention. In this embodiment, the second reflective integrator 23 includes plural elements 231 arranged two-dimensionally along a reference plane (for example, a plane perpendicular to the optical axis of the illumination optical apparatus 3). Each element 231 in this embodiment has a rectangular profile (outline) but the profile is not limited to the rectangular shape but may have other shapes such as a circular shape. The reflection surface of each element 231 has a predetermined curvature. Plural element groups 230 in which the elements 231 are arbitrarily combined are formed in the second reflective integrator 23. The plural element groups 230 formed in the second reflective integrator 23 in this embodiment include a first element group 230A, a second element group 230B, and a third element group 2300. In this embodiment, the plural element groups 230 roughly have a substantially circular shape in terms of the arrangement of the elements 231.

Optical images are formed in the reflection surfaces of the plural elements 231 constituting the element groups 230 of the second reflective integrator 23, respectively, by the first reflective integrator 22. The element groups 230 of the second reflective integrator 23 serve as a field mirror group forming a secondary light source including plural light source images.

In this embodiment, the first element group 230A has a circular illumination area. In this embodiment, the second element group 230B has two illumination areas which are symmetric about the illumination area of the element group 230A (located at three o'clock and nine o'clock with respect to the illumination area of the element group 230A). In this embodiment, the third element group 230C has two illumination areas which are symmetric about the illumination area of the element group 230A (located at six o'clock and twelve o'clock with respect to the illumination area of the element group 230A).

Referring to FIG. 2 again, the first reflective integrator 22 has a function of dividing the incident exposure light EL into plural light beams and causing the respective light beams to be incident on the second reflective integrator 23. In the first reflective integrator 22, plural elements (reflection elements) 221 are arranged two-dimensionally along a reference plane (for example, a plane perpendicular to the optical axis of the illumination optical apparatus 3). The first reflective integrator 22 has a substantially circular shape in terms of the arrangement of the elements 221. Bach element 221 in this embodiment has an arc-like profile (outline). The reflection surface of each element 221 has a predetermined curvature. An optical image of a light source is formed in the reflection surface of each element 231 of the second reflective integrator 23. The number of light beams into which the exposure light can be divided by the first reflective integrator 22 is the same as the number of elements 221. In FIG. 2, four elements 221A, 221B, 221C, and 221D are shown as the elements 221 of the first reflective integrator 22, but the first reflective integrator 22 actually includes, for example, 400 elements 221 and has a function of dividing the exposure light EL into 400 light beams.

Referring to FIG. 1 again, the illumination optical apparatus 3 includes an illumination device (irradiation device) 40 including the first reflective integrator 22. The illumination device 40 has a function of selecting the element groups 230 of the second reflective integrator 23 to be illuminated with the exposure light EL incident on the first reflective integrator 22 depending on the types of the pattern formed on the mask. The illumination device 40 in this embodiment includes a driving unit 5 changing the slope, position, and curvature of the reflection surface of the respective elements 221 of the first reflective integrator 22. The driving unit 5 includes a mirror driving system 41 which is connected to the main control system 31 and which controls the driving of the elements 221 (controls the posture, position, and shape).

The driving unit 5 includes first actuators 42 changing the slope and position of the reflection surface of the respective elements 221 of the first reflective integrator 22 under the control of the mirror driving system 41 (see FIG. 2). In this embodiment, the first actuators 42 are disposed in the elements 221, respectively, to independently drive the elements 221. In this embodiment, each actuator 42 is constructed, for example, with a piezoelectric actuator. Each element 221 can be driven in a single-axis direction, in a multi-axis direction, and around the axes with the expansion and contraction of the corresponding actuator 42. Each element 221 is supported by a frame 43 fixed to a predetermined position with the corresponding actuator 42 interposed therebetween. In this embodiment, each first actuator 42 drives the corresponding element 221 under the control of the mirror driving system 41 so as to change the slope of the reflection surface of the corresponding element and to switch an illumination position (incidence position) of the exposure light EL on the second reflective integrator 23.

FIG. 4 is a cross-sectional view illustrating an element 221 of the first reflective integrator 22 in the first embodiment of the invention. The driving unit 5 includes second actuators 44 changing the curvature of the reflection surface of each element 221 of the first reflective integrator 22 under the control of the mirror driving system 41.

The second actuators 44 in this embodiment are disposed along the bottom surfaces of plural grooves 222 formed in the opposite surface of the reflection surface of each element 221. The bottom surface of each groove 222 has a plane substantially parallel to the reflection surface. In this embodiment, each second actuator 44 is constructed, for example, with a thin-film piezoelectric actuator. The reflection surface of each element 221 suffers from a stress with the expansion and contraction of the second actuators 44 and the curvature thereof is changed to a predetermined curvature. In this embodiment, when the illumination position of the exposure light EL is changed by the first actuator 42 under the control of the mirror driving system 41, the second actuators 44 change the curvature of the reflection surface of the corresponding element 221 to adjust the focal length so as to cancel the influence on the optical image due to the variation in optical path length in the reflection surface of the element 231 of the second reflective integrator 23.

The mirror driving system 41 includes a voltage supply unit that individually applies a variable voltage to the first actuator 42 and the second actuators 44 to change the slope, position, and curvature of the corresponding element 221. The mirror driving system 41 includes a storage unit storing a data table representing the relationship between voltages applied to the first actuator 42 and the second actuators 44 and the change in slope, position, and curvature of the reflection surface of the corresponding element 221 due to the voltages. The storage unit stores a data table representing the relationship between plural illumination conditions which can be formed by the element groups 230 of the second reflective integrator 23 and the slope, position, and curvature of the reflection surface of the respective elements 221 of the first reflective integrator 22 for switching the illumination position of the exposure light EL to the element groups 230 corresponding to the illumination conditions. When one of the plural illumination conditions is selected by the main control system 31, the mirror driving system 41 calculates the slope, position, and curvature of the reflection surface of the respective elements 221 of the first reflective integrator 22 corresponding to the illumination condition on the basis of the data table stored in the storage unit. Then, the mirror driving system 41 acquires control values of the voltages supplied to the first actuator 42 and the second actuators 44 to correspond to the calculated slope, position, and curvature of the reflection surface of the respective elements 221 on the basis of the data table stored in the storage unit. The mirror driving system 41 is configured to change the slope, position, and curvature of the reflection surface of the respective elements 221 of the first reflective integrator 22 depending on the selected illumination condition by driving the voltage supply unit on the basis of the control values.

An illumination condition switching (changing) operation of the illumination optical apparatus 3 according to this embodiment will be described below with reference to FIG. 2 and FIGS. 5 to 9.

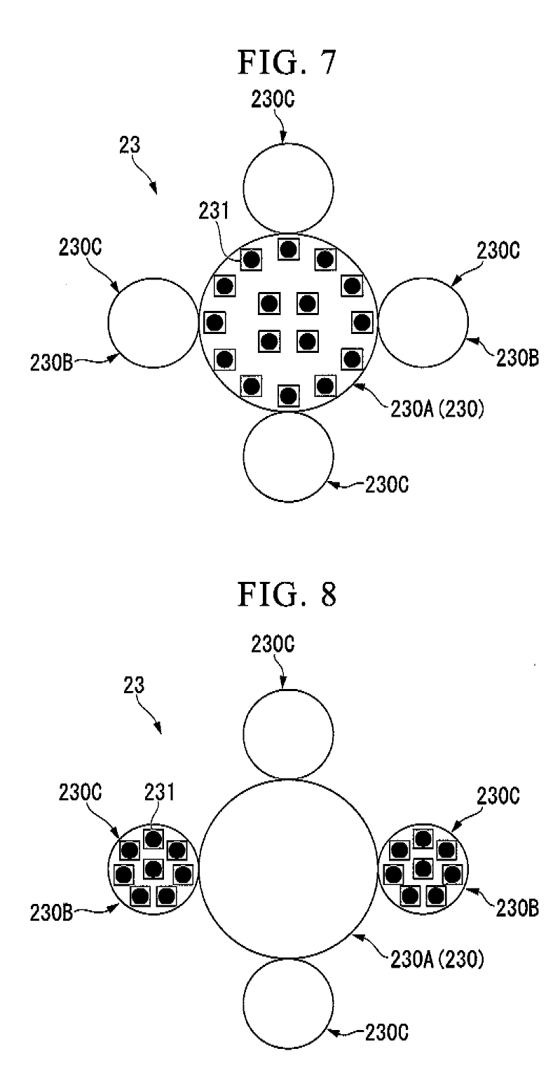

The illumination optical apparatus 3 performs an operation of switching the σ value to a desired value (for example, a value in the range of 0.1 to 0.9) by the use of a modified illumination of changing the shape of the secondary light source in the second reflective integrator 23 as an illumination condition. Specifically, FIG. 2 and FIGS. 5 to 9 show a normal illumination (conventional illumination: first illumination condition) which is formed by the first element group 230A of the second reflective integrator 23, a dipolar illumination (first dipolar illumination: second illumination condition) which is formed by the second element group 2303 of the second reflective integrator 23, a dipolar illumination (second dipolar illumination: an illumination condition (third illumination condition) in which dipoles are formed in the direction perpendicular to the first dipolar illumination) which is formed by the third element group 230C of the second reflective integrator 23, and a tetrapolar illumination (quarto-polar illumination: fourth illumination condition) which is formed by the second and third element groups 230B and 230C of the second reflective integrator 23. The black plots in FIGS. 7 to 9 represent the illumination positions of the exposure light EL divided into plural light beams by the first reflective integrator 22 on the second reflective integrator 23. The light beams of the exposure light EL are represented by 16 black plots in FIGS. 7 to 9, but 400 light beams of the exposure light EL are actually incident on the second reflective integrator 23.

FIGS. 2 and 7 are diagrams illustrating the state of the illumination optical apparatus 3 in a case of the normal illumination.

As shown in the drawings, when the normal illumination is selected as the first illumination condition by the main control system 31, the illumination optical apparatus 3 drives the illumination device 40 to cause the exposure light EL incident on the first reflective integrator 22 to be incident on the first element group 230A of the second reflective integrator 23. The first element group 230A of the second reflective integrator 23 includes a single illumination area and the total number of elements 231 constituting the illumination area is the same as the total number of elements 221 constituting the first reflective integrator 22. The driving unit 5 changes the slope, position, and the curvature of the reflection surface of the respective elements 221 of the first reflective integrator 22 so that the elements 221 of the first reflective integrator 22 and the elements 231 of the element group 230A have one-to-one correspondence. That is, in the illumination area of the first element group 230A, 400 light beams of the exposure light EL are incident on the reflection surfaces of 400 elements 231 in total, respectively.

The mirror driving system 41 acquires the control values of the first actuators 42 and the second actuators 44 corresponding to the first illumination condition on the basis of the data table stored in the storage unit. The mirror driving system 41 changes the slope, position, and curvature of the reflection surfaces of the elements 221 of the first reflective integrator 22 on the basis of the first illumination condition by driving the voltage supply unit on the basis of the acquired control values. As shown in FIG. 2, the first actuators 42 are independently driven under the control of the mirror driving system 41 to change the slopes of the reflection surfaces of the elements 221 (the elements 221A, 221B, 221C, and 221D) and to switch the illumination position of the exposure light EL on the second reflective integrator 23 to the illumination area of the first element group 230A.

When the illumination position of the exposure light EL is changed by the first actuator 42 under the control of the mirror driving system 41, the second actuators 44 change the curvature of the reflection surfaces of the elements 221 to adjust the focal length so as to cancel the influence on the optical images due to the variation in optical path length in the reflection surfaces of the elements 231 of the second reflective integrator 23. The first actuators 42 may minutely move the positions in a predetermined axis direction along with the slopes of the reflection surfaces of the elements 221 to minutely adjust the positions of optical images formed on the reflection surfaces of the elements 231.

The illumination optical apparatus 3 switches the illumination condition to the normal illumination shown in FIG. 7 through this operation to change the σ value.

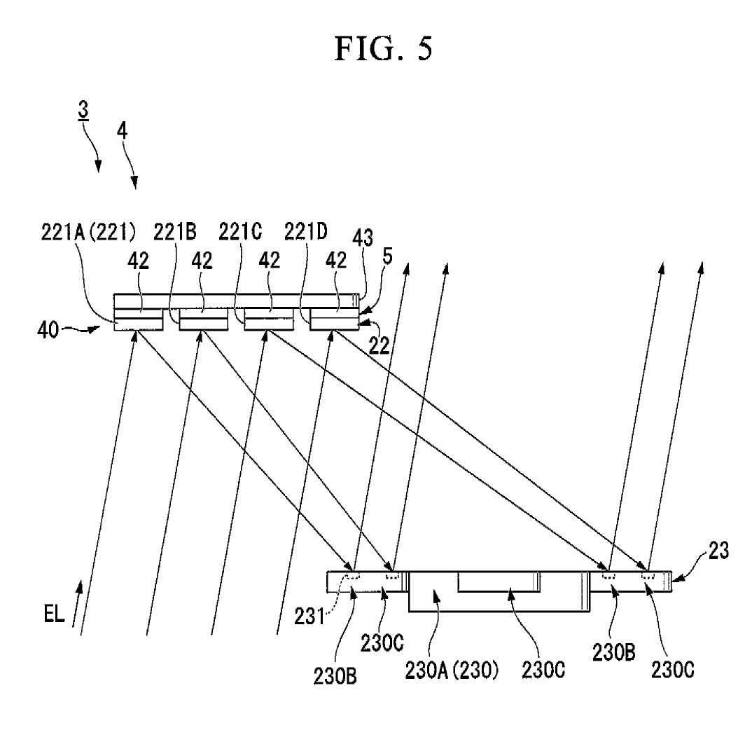

FIGS. 5 and 8 are diagrams illustrating the state of the illumination optical apparatus 3 in a case of the dipolar illumination (second illumination condition).

As shown in the drawings, when the dipolar illumination is selected as the second illumination condition by the main control system 31, the illumination optical apparatus 3 drives the illumination device 40 to cause the exposure light EL incident on the first reflective integrator 22 to be incident on the element group 230B of the second reflective integrator 23. The element group 230B of the second reflective integrator 23 includes two illumination areas and the total number of elements 231 constituting the two illumination areas are the same as the total number of elements 221 constituting the first reflective integrator 22. The driving unit 5 changes the slope, position, and the curvature of the reflection surface of the respective elements 221 of the first reflective integrator 22 so that the elements 221 of the first reflective integrator 22 and the elements 231 of the element group 230B have one-to-one correspondence. That is, in the two illumination areas of the element group 230B, 400 light beams of the exposure light EL are divided into two parts and the light beams of the exposure light EL are incident on the reflection surfaces of the 400 elements 231 in total, respectively.

The mirror driving system 41 acquires the control values of the first actuators 42 and the second actuators 44 corresponding to the second illumination condition on the basis of the data table stored in the storage unit. The mirror driving system 41 changes the slope, position, and curvature of the reflection surface of the respective elements 221 of the first reflective integrator 22 on the basis of the second illumination condition by driving the voltage supply unit on the basis of the acquired control values. As shown in FIG. 5, the first actuators 42 change the slopes of the reflection surfaces of the elements 221A and the elements 221B under the control of the mirror driving system 41 to switch the illumination position of the exposure light EL to one illumination area (the illumination area located at 9 o'clock) of the element group 230B. The first actuators 42 change the slopes of the reflection surfaces of the elements 221C and the elements 221D under the control of the mirror driving system 41 to switch the illumination position of the exposure light EL to the other illumination area (the illumination area located at 3 o'clock) of the element group 230B.

Similarly, when the illumination position of the exposure light EL is changed by the first actuators 42 under the control of the mirror driving system 41, the second actuators 44 change the curvature of the reflection surfaces of the elements 221 to adjust the focal length so as to cancel the influence on the optical image due to the variation in optical path length in the reflection surfaces of the elements 231 of the second reflective integrator 23. Similarly, the first actuators 42 may minutely move the positions of the reflection surfaces in a predetermined axis direction along with the slopes of the reflection surfaces of the elements 221 to minutely adjust the positions of the optical images formed on the reflection surfaces of the elements 231.

The illumination optical apparatus 3 may change the slopes of the reflection surfaces of the elements 221A and the elements 221B to switch the illumination position of the exposure light EL to the other illumination area (the illumination area located at 9 o'clock) of the element group 230B, and may change the slopes of the reflection surfaces of the elements 221C and the elements 221D to switch the illumination position of the exposure light EL to one illumination area (the illumination area located at 3 o'clock) of the element group 230B.

In order to form the dipolar illumination (the third illumination condition), the illumination optical apparatus 3 changes the slopes of the reflection surfaces of the elements 221A and the elements 221B to switch the illumination position of the exposure light EL to one illumination area (the illumination area located at 12 o'clock) of the element group 230C, and changes the slopes of the reflection surfaces of the elements 221C and the elements 221D to switch the illumination position of the exposure light EL to the other illumination area (the illumination area located at 6 o'clock) of the element group 230C. As another dipolar illumination, the illumination optical apparatus 3 may switch the illumination position of the exposure light EL to one illumination area (the illumination area located at 3 o'clock) of the element group 230B or the other illumination area (the illumination area located at 12 o'clock) of the element group 230C, or may switch the illumination position of the exposure light EL to the other illumination area (the illumination area located at 9 o'clock) of the element group 230B or the one illumination area (the illumination area located at 6 o'clock) of the element group 230C. The illumination optical apparatus 3 switches the illumination condition to the dipolar illumination shown in FIG. 8 through this operation to change the σ value.

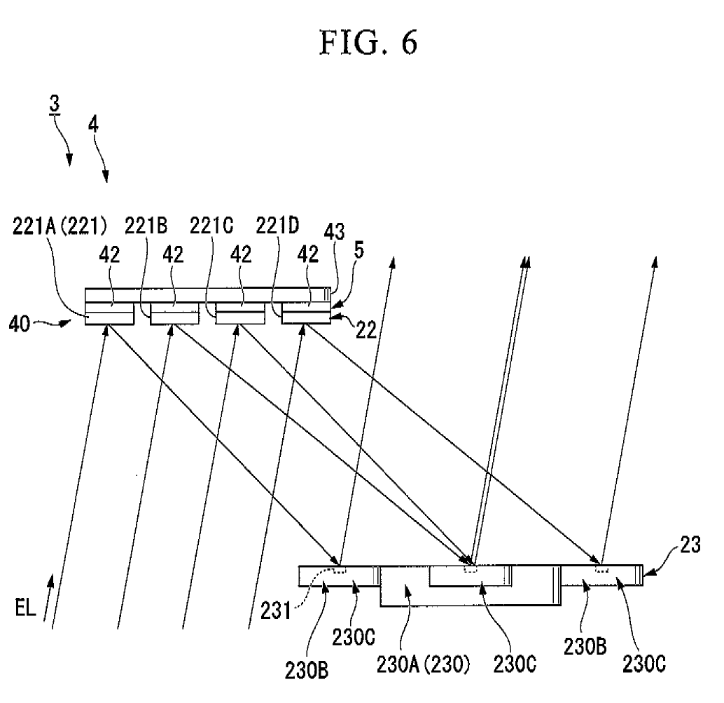

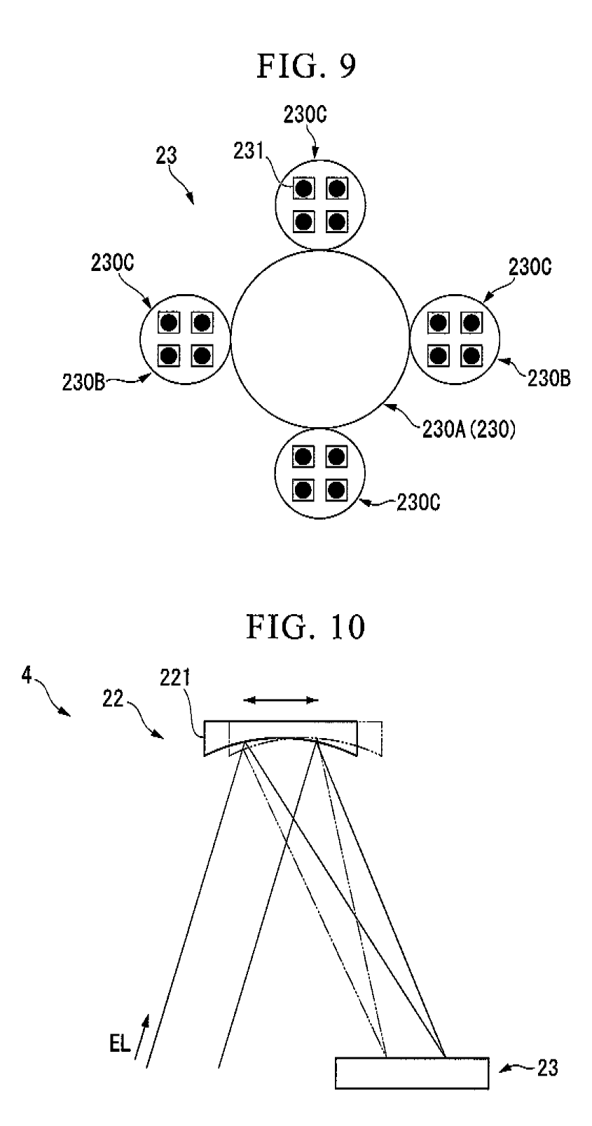

FIGS. 6 and 9 are diagrams illustrating the state of the illumination optical apparatus 3 in a case of the tetrapolar illumination.

As shown in the drawings, when the tetrapolar illumination is selected as the third illumination condition by the main control system 31, the illumination optical apparatus 3 drives the illumination device 40 to cause the exposure light EL incident on the first reflective integrator 22 to be incident on the second element group 230B and the third element group 230C of the second reflective integrator 23. The two illumination areas of the second element group 230B and the two illumination areas of the third element group 230C each include 100 elements 221. That is, the total number of elements 231 in the four illumination areas formed in the second element group 230B and the third element group 230C is the same as the total number of elements 221 constituting the first reflective integrator 22. The driving unit 5 changes the slope, position, and the curvature of the reflection surface of the respective elements 221 of the first reflective integrator 22 so that the elements 221 of the first reflective integrator 22 and the elements 231 of the second element group 230B and the third element group 230C have one-to-one correspondence. That is, in the four illumination areas of the second element group 230B and the third element group 230C, 400 light beams of the exposure light EL are divided into four parts and are incident on the reflection surfaces of the 400 elements 231 in total, respectively.

The mirror driving system 41 acquires the control values of the first actuators 42 and the second actuators 44 corresponding to the third illumination condition on the basis of the data table stored in the storage unit. The mirror driving system 41 changes the slope, position, and curvature of the reflection surface of the respective elements 221 of the first reflective integrator 22 corresponding to the third illumination condition by driving the voltage supply unit on the basis of the acquired control values. As shown in FIG. 6, the first actuators 42 change the slopes of the reflection surfaces of the elements 221A under the control of the mirror driving system 41 to switch the illumination position of the exposure light EL to the illumination area located at 9 o'clock in the second element group 230B and change the slopes of the reflection surfaces of the elements 221B to switch the illumination position of the exposure light EL to the illumination area located at 6 o'clock in the third element group 230C. The first actuators 42 change the slopes of the reflection surfaces of the elements 221C under the control of the mirror driving system 41 to switch the illumination position of the exposure light EL to the illumination area located at 12 o'clock in the third element group 230C and change the slopes of the reflection surfaces of the elements 221D to switch the illumination position of the exposure light EL to the illumination area located at 3 o'clock in the second element group 230B.

Similarly, when the illumination position of the exposure light EL is changed by the first actuators 42 under the control of the mirror driving system 41, the second actuators 44 change the curvature of the reflection surfaces of the elements 221 to adjust the focal length so as to cancel the influence on the optical image due to the variation in optical path length in the reflection surfaces of the elements 231 of the second reflective integrator 23. Similarly, the first actuators 42 may minutely move the positions of the reflection surfaces in a predetermined axis direction along with the slopes of the reflection surfaces of the elements 221 to minutely adjust the positions of the optical images formed on the reflection surfaces of the elements 231.

The illumination optical apparatus 3 switches the illumination condition to the tetrapolar illumination shown in FIG. 9 through this operation to change the σ value.

In the illumination optical apparatus 3, the elements 221A, 221B, 221C, and 221B and the element groups 230B and 230C can be arbitrarily combined.

As described above, in the illumination optical apparatus 3 according to this embodiment, it is possible to suppress the loss in light intensity of the illumination light due to the change in illumination condition.

According to this embodiment, it is possible to provide an exposure apparatus 1 including the illuminating optical apparatus 3 which can achieve the above-mentioned advantage and a device manufacturing method using the exposure apparatus 1.

It has been stated in the above-mentioned embodiment that the first actuators 42 change the slopes of the reflection surfaces of the elements 221 of the first reflecting integrator 22 under the control of the mirror driving system 41 to switch the illumination position of the exposure light EL on the second reflective integrator 23, but the invention is not limited to this configuration.

For example, as shown, in FIG. 10, the first actuators 42 may change the positions of the reflection surfaces of the elements 221 of the first reflective integrator 22 under the control of the mirror driving system 41 to switch the illumination position of the exposure light EL on the second reflective integrator 23. When the positions of the reflection surfaces of the elements 221 in the first reflective integrator 22 are changed, for example, in a predetermined axis direction by the first actuators 42, the curvature of the area on which the exposure light EL is incident is changed and the illumination position of the exposure light EL on the second reflective integrator 23 is changed. Accordingly, the illumination position of the exposure light EL on the second reflective integrator 23 may be switched by this configuration.

When the curvature of the area on which the exposure light EL is changed by the elements 221, the illumination position of the exposure light EL on the second reflective integrator 23 is switched. Accordingly, for example, the second actuators 44 may change the curvatures of the reflection surfaces of the elements 221 of the first reflective integrator 22 under the control of the mirror driving system 41 to switch the illumination position of the exposure light EL on the second reflective integrator 23.

### Second Embodiment

A second embodiment of the invention will be described below. In the following description, elements identical or equivalent to those of the above-mentioned embodiment are referenced by identical reference signs and the description thereof will be made brief or will not be repeated. The description may be made with reference to the drawings used in the above-mentioned embodiment.

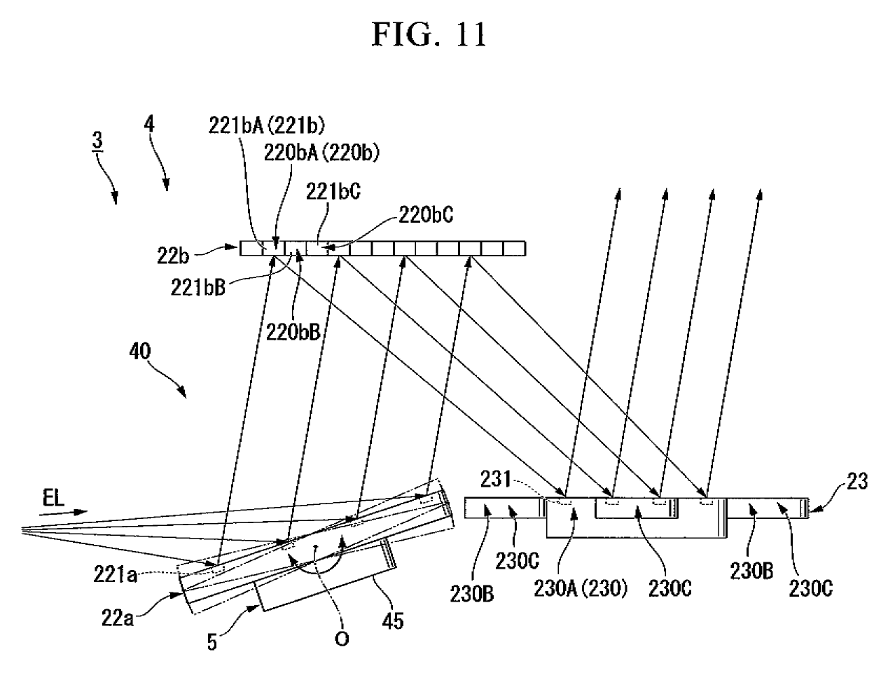

FIG. 11 is a diagram illustrating the configuration of an optical integrator 4 of an illumination optical apparatus 3 according to the second embodiment of the invention. In the second embodiment, the optical integrator 4 includes a reflective integrator 22a located at a position optically conjugate to the reticle R as an illuminated plane or in the vicinity of the conjugate position and a reflective integrator 23 located at a position optically conjugate to the pupil of the projection optical system PO or in the vicinity of the conjugate position. The reflective integrator 23 has the same configuration as the second reflective integrator 23 in the above-mentioned embodiment. In the following description, the reflective integrator 22a is also referred to as a first reflective integrator (second reflective optical member) 22a, the reflective integrator 22b is also referred to as a first reflective integrator (first reflective optical member) 22b, and the reflective integrator 23 is also referred to as a second reflective integrator 23.

In the second embodiment, the first reflective integrator 22a and the first reflective integrator 22b cooperate with each other to achieve the same function as the first reflective integrator 22 in the above-mentioned embodiment.

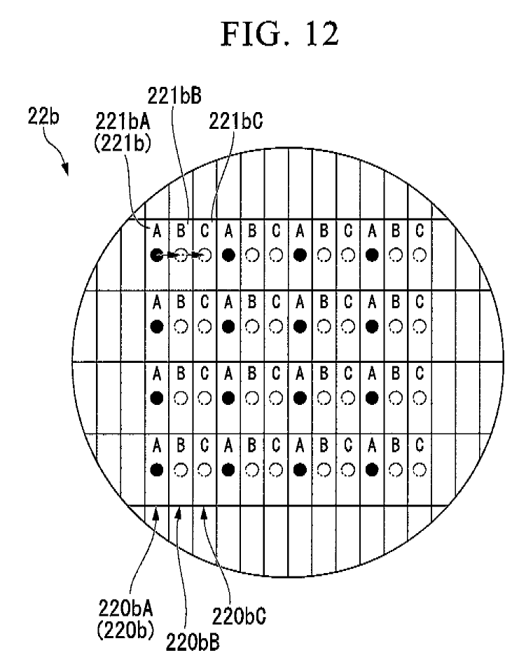

FIG. 12 is a plan view illustrating the first reflective integrator 22b in the second embodiment of the invention. In this embodiment, the first reflective integrator 22b includes plural elements 221b arranged two-dimensionally along a reference plane. The first reflective integrator 22b has a substantially circular shape in terms of the arrangement of the elements 221b. Each element 221b in this embodiment has a rectangular profile (outline). The reflection surface of each element 221b has a predetermined curvature.

The first reflective integrator 22b includes plural element groups 220b having the elements 221b arbitrarily combined and reflecting the incident exposure light EL to the illumination positions corresponding to the element groups 230 of the second reflective integrator 23. The first reflective integrator 22b in this embodiment includes element groups 220bA, 220bB, and 220bC. The first reflective integrator 22b serves as a vertical-incidence mirror.

The element group (first reflection area) 220bA of the first reflective integrator 22b includes plural elements 221bA (to which sign A is attached in FIG. 12) having the reflection characteristics (characteristics including the slope, position, and curvature of the reflection surfaces) corresponding to the element group 230A of the second reflective integrator 23. The element group (second reflection area) 220bB of the first reflective integrator 22b includes plural elements 221bB (to which sign B is attached in FIG. 12) having the reflection characteristics corresponding to the element group 230B of the second reflective integrator 23. The element group 220bC of the first reflective integrator 22b includes plural elements 221bC (to which sign C is attached in FIG. 12) having the reflection characteristics corresponding to the element group 230C of the second reflective integrator 23. The first reflective integrator 22b in this embodiment includes 400 elements 221bA, 400 elements 221bB, and 400 elements 221bC, that is, 1200 elements 221b in total.

Referring to FIG. 11 again, the first reflective integrator 22a has a function of dividing the incident exposure light EL into plural light beams and causing the respective light beams to be incident on the first reflective integrator 22b. In the first reflective integrator 22a, plural elements 221a are arranged two-dimensionally along a reference plane. The first reflective integrator 22a has a substantially circular shape in terms of the arrangement of the elements 221. Each element 221a in this embodiment has an arc-like profile (outline). The reflection surface of each element 221a has a predetermined curvature. Accordingly, an optical image of a light source is formed in the reflection surface of each element 221b of the first reflective integrator 22b. The number of light beams into which the exposure light can be divided by the first reflective integrator 22a is the same as the number of elements 221a. The first reflective integrator 22a includes 400 elements 221a and has a function of dividing the incident exposure light EL into 400 light beams. The first reflective integrator 22a serves as an oblique-incidence mirror. The exposure light EL incident on the first reflective integrator 22a may be light reflected from the concave mirror 21, or the concave mirror 21 may be removed without providing the first reflective integrator 22a and the light reflected from the condenser mirror 13 may be incident on the first reflective integrator 22.

The illumination optical apparatus 3 includes an illumination device 40 including the first reflective integrator 22a and the first reflective integrator 22b. In this embodiment, the illumination device 40 includes a driving unit (second driving unit) 5 driving the first reflective integrator 22a so as to reflect (direct) the exposure light EL incident on the first reflective integrator 22a to any one of the element groups 220b of the first reflective integrator 22b. The driving unit 5 includes a mirror driving system 41 which is connected to the main control system 31 to control the driving (see FIG. 1), similarly to the above-mentioned embodiment.

The driving unit 5 includes an actuator 45 driving the first reflective integrator 22a around a predetermined axis (to which sign O is attached in FIG. 11) under the control of the mirror driving system 41. In this embodiment, the actuator 45 is constructed, for example, with a piezoelectric actuator. The first reflective integrator 22a, can be displaced around the O axis (for example, the X axis) with the expansion and contraction of the actuator 45. In this embodiment, the actuator 45 changes the slope of the first reflective integrator 22a around the O axis under the control of the mirror driving system 41 to execute a driving that switches the illumination position of the exposure light EL relative to the first reflective integrator 22b.

The driving unit 5 includes actuators 44 changing the curvature of the reflection surface of the respective elements 221a of the first reflective integrator 22a under the control of the mirror driving system 41 (see FIG. 4).

The mirror driving system 41 includes a voltage supply unit applying a variable voltage to the actuator 45 to drive the first reflective integrator 22a. The mirror driving system 41 further includes a storage unit storing a data table representing the relationship between a voltage applied to the actuator 45 and the slope of the first reflective integrator 22a about the O axis based on the voltage. The storage unit stores a data table representing the relationship between positions of the element groups 220b of the first reflective integrator 22b and the slope of the first reflective integrator 22a about the O axis for switching the illumination position of the exposure light EL relative to the respective element groups 220b. When one of plural illumination conditions is selected by the main control system 31, the mirror driving system 41 calculates the position of the element group 220b of the first reflective integrator 22a having the reflection characteristics corresponding to the selected illumination condition and acquires the slope of the first reflective integrator 22a about the O axis corresponding to the position. Then, the mirror driving system 41 acquires a control value of the voltage applied to the actuator 45 to correspond to the acquired slope of the first reflective integrator 22a about the O axis on the basis of the data table stored in the storage unit. The mirror driving system 41 changes the slope of the first reflective integrator 22a about the O axis depending on the selected illumination condition by driving the voltage supply unit on the basis of the control value.

An illumination condition switching (changing) operation of the illumination optical apparatus 3 according to this embodiment will be described below.

The illumination optical apparatus 3 performs an operation of switching the σ value to a desired value (for example, a value in the range of 0.1 to 0.9) by the use of a modified illumination of changing the shape of the secondary light source in the second reflective integrator 23 as an illumination condition. The black plots in FIG. 12 represent the illumination positions of the exposure light EL divided into plural light beams by the first reflective integrator 22a on the first reflective integrator 22b. The light beams of the exposure light EL are represented by 16 black plots in FIG. 12, but 400 light beams of the exposure light EL are actually incident on the first reflective integrator 22b.

When the normal illumination is selected as the first illumination condition by the main control system 31, the illumination optical apparatus 3 drives the illumination device 40 to cause the exposure light EL incident on the first reflective integrator 22a to be incident on the element group 220bA of the first reflective integrator 22b. Since the element group 220bA of the first reflective integrator 22b includes the elements 221bA having reflection characteristics corresponding to the element group 230A of the second reflective integrator 23, the exposure light EL incident on the element group 220bA is reflected toward the element group 230A of the second reflective integrator 23. The element group 230A of the second reflective integrator 23 forms the secondary light source of the normal illumination shown in FIG. 7.

When the dipolar illumination is selected as the second illumination condition by the main control system 31, the illumination optical apparatus 3 drives the illumination device 40 to cause the exposure light EL incident on the first reflective integrator 22a to be incident on the element group 220bB of the first reflective integrator 22b. Since the element group 220bB of the first reflective integrator 22b includes the elements 221bB having reflection characteristics corresponding to the element group 230B of the second reflective integrator 23, the exposure light EL incident on the element group 220bB is reflected toward the element group 230B of the second reflective integrator 23. The element group 230B of the second reflective integrator 23 forms the secondary light source of the dipolar illumination shown in FIG. 8.

When the tetrapolar illumination is selected as the third illumination condition by the main control system 31, the illumination optical apparatus 3 drives the illumination device 40 to cause the exposure light EL incident on the first reflective integrator 22a to be incident on the element group 220bC of the first reflective integrator 22b. Since the element group 220bC of the first reflective integrator 22b includes the elements 221bC having reflection characteristics corresponding to the element group 230C of the second reflective integrator 23, the exposure light EL incident on the element group 220bC is reflected toward the element group 230C of the second reflective integrator 23. The element group 230C of the second reflective integrator 23 forms the secondary light source of the tetrapolar illumination shown in FIG. 9.

As described above, in the illumination optical apparatus 3 according to this embodiment, it is possible to suppress the loss in light intensity of the illumination light due to the change in illumination condition, similarly to the first embodiment.

In the illumination optical apparatus 3 according to this embodiment, it is possible to reduce the number of actuators driving the first reflective integrator, compared with the illumination optical apparatus 3 according to the first embodiment. Accordingly, it is possible to simplify programs and the like of the control system controlling the driving of the first reflective integrator, to reduce the burden of the control system, and to control the driving of the first reflective integrator with high accuracy. It is possible to contribute to a decrease in cost.

### Third Embodiment

A third embodiment of the invention will be described below. In the following description, elements identical or equivalent to those of the above-mentioned embodiment are referenced by identical reference signs and the description thereof will be made brief or will not be repeated. The description may be made with reference to the drawings used in the above-mentioned embodiment.

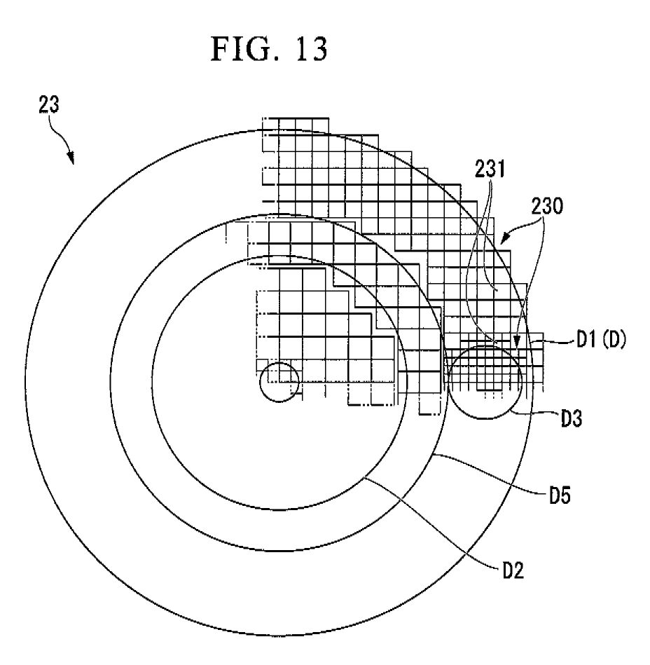

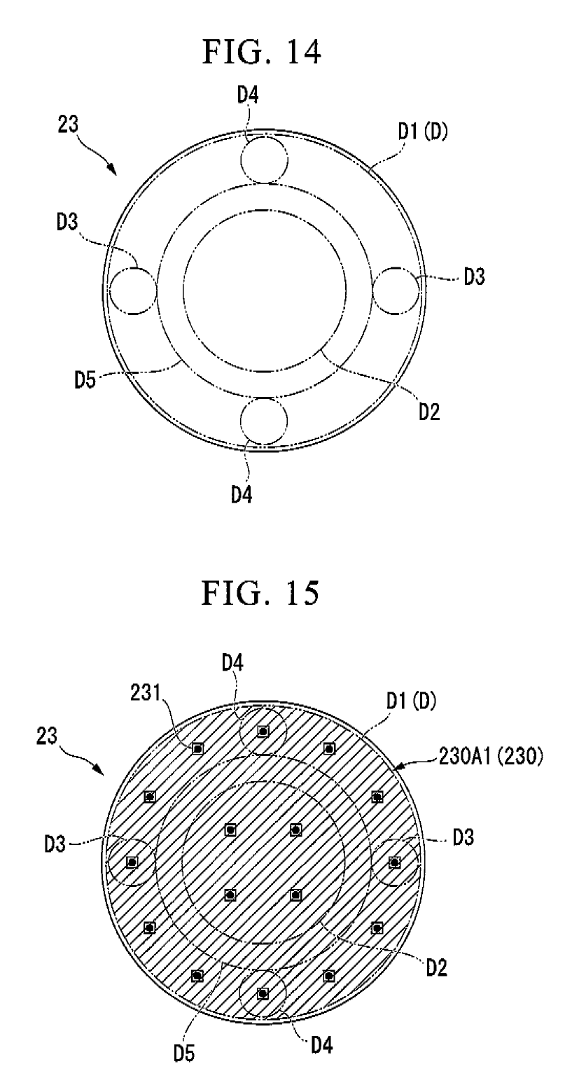

FIG. 13 is a plan view illustrating a second reflective integrator 23 in a third embodiment of the invention. FIG. 14 is a diagram schematically illustrating a second reflective integrator 23 in the third embodiment of the invention. As shown in FIG. 13, in the second reflective integrator 23 of this embodiment, plural elements 231 are two-dimensionally arranged along a reference plane. The second reflective integrator 23 has a substantially circular shape in terms of the arrangement of the elements 231. In this embodiment, the second reflective integrator 23 includes plural element groups 230 surrounded with plural boundary lines D (boundary lines D1 to D5), which are shown in FIG. 14, drawing the profile (outline) of predetermined illumination conditions and the respective element groups 230 form a predetermined illumination condition.

In the third embodiment, some of the elements 231 constituting the respective element group 230 are used in common under the predetermined illumination conditions. The sizes of the reflection surfaces of the elements 231 are not constant but vary depending on the positions of the element groups 230 (illumination conditions). The density of the elements 231 differs depending on the positions of the element groups 230 (illumination conditions).

Examples of the illumination conditions which can be formed by the second reflective integrator 23 of this embodiment will be described below with reference to FIGS. 15 to 20. In the following description, for example, the illumination device 40 in the first embodiment can be used as the illumination device 40 switching the illumination position of the exposure light EL relative to the second reflective integrator 23. In the areas surrounded with the boundary lines D1 to D5 shown in FIGS. 15 to 20, at least the elements 231 of the same number as the total number of elements 221 of the first reflective integrator 22 are arranged. The black plots in FIGS. 15 to 20 represent the illumination positions of the exposure light EL divided into plural light beams by the first reflective integrator 22 on the second reflective integrator 23. The light beams of the exposure light EL are represented by 16 black plots in FIGS. 15 to 20, but 400 light beams of the exposure light EL are actually incident on the second reflective integrator 23.

The illumination device 40 reflects (directs) the exposure light EL incident on the first reflective integrator 22 to the element group (first element group) 230A1 in the area surrounded with the boundary line D1 in the second reflective integrator 23 shown in FIG. 15. Accordingly, the element group 230A1 of the second reflective integrator 23 can form (prescribe) the secondary light source of the normal illumination as a first illumination condition.

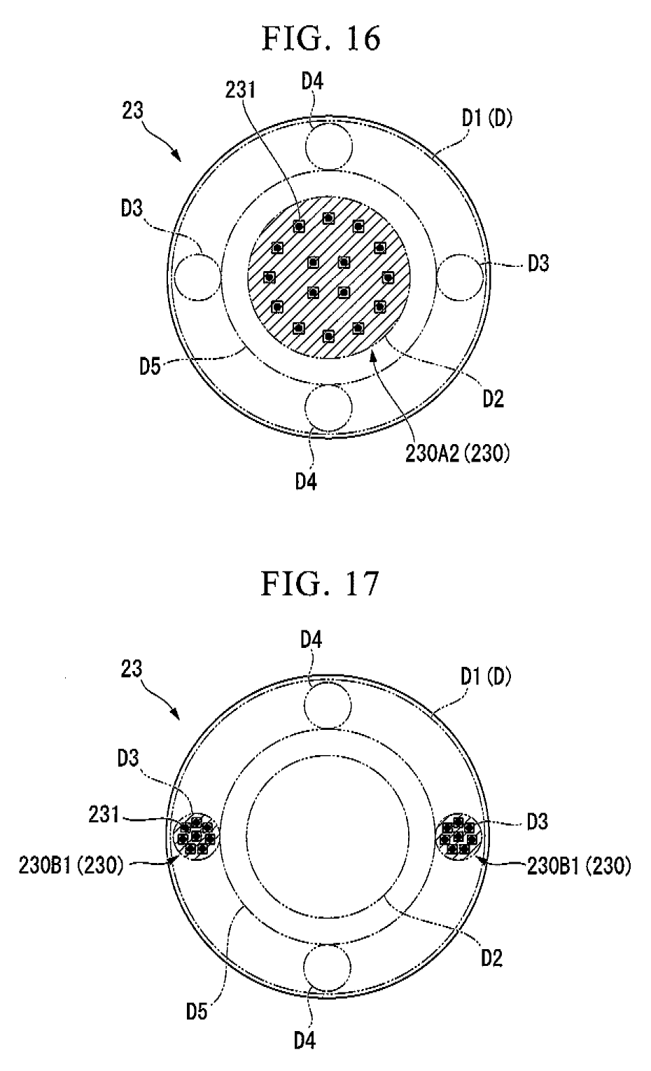

The illumination device 40 reflects (directs) the exposure light EL incident on the first reflective integrator 22 to the element group (second element group) 230A2 in the area surrounded with the boundary line D2 in the second reflective integrator 23 shown in FIG. 16. Accordingly, the element group 230A2 of the second reflective integrator 23 can form (prescribe) the secondary light source of the normal illumination having a diameter smaller than that of the first illumination condition as a second illumination condition.

The illumination device 40 reflects (directs) the exposure light EL incident on the first reflective integrator 22 to the element group (third element group) 230B1 in the area surrounded with the boundary line D3 in the second reflective integrator 23 shown in FIG. 17. Accordingly, the element group 230B1 of the second reflective integrator 23 can form (prescribe) the secondary light source of the dipolar illumination as a third illumination condition.

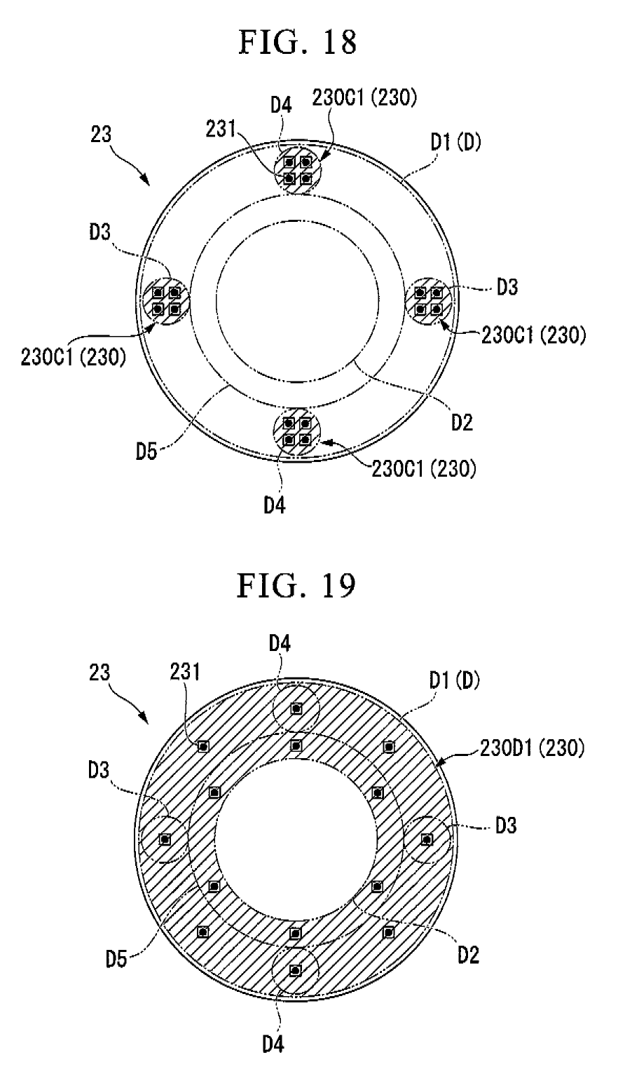

The illumination device 40 reflects (directs) the exposure light EL incident on the first reflective integrator 22 to the element group 230C1 in the area surrounded with the boundary lines D3 and D4 in the second reflective integrator 23 shown in FIG. 18. Accordingly, the element group 230C1 of the second reflective integrator 23 can form (prescribe) the secondary light source of the tetrapolar illumination as a fourth illumination condition.

The illumination device 40 reflects (directs) the exposure light EL incident on the first reflective integrator 22 to the element group 230D1 in the area surrounded with the boundary lines D1 and D2 in the second reflective integrator 23 shown in FIG. 19. Accordingly, the element group 230D1 of the second reflective integrator 23 can form (prescribe) the secondary light source of the orbicular-zone (annular) illumination as a fifth illumination condition.

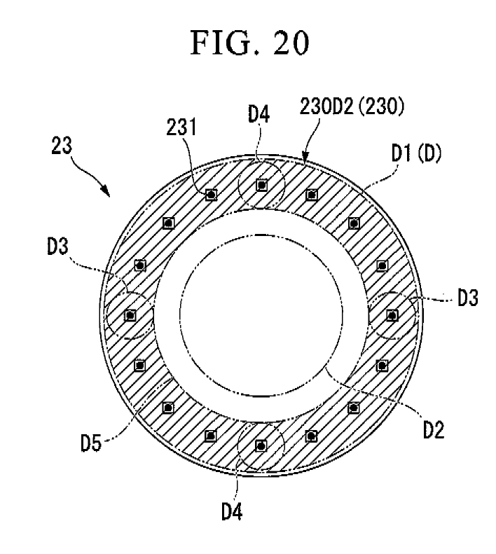

The illumination device 40 reflects (directs) the exposure light EL incident on the first reflective integrator 22 to the element group 230D2 in the area surrounded with the boundary lines D1 and D5 in the second reflective integrator 23 shown in FIG. 20. Accordingly, the element group 230D2 of the second, reflective integrator 23 can form (prescribe) the secondary light source of the orbicular-zone illumination having an inner diameter larger than that of the fifth condition as a sixth illumination condition.

As described above, in the illumination optical apparatus 3 according to this embodiment, it is possible to suppress the loss in light intensity of the illumination light due to the change in illumination condition, similarly to the above-mentioned embodiment.

In the illumination optical device 3 according to this embodiment, since some elements 231 constituting any element group 230 are used in common under predetermined illumination conditions, it is possible to reduce the total number of elements 231 constituting the second reflective integrator 23. Accordingly, it is possible to contribute to a decrease in cost.

### Fourth Embodiment

A fourth embodiment of the invention will be described below. In the following description, elements identical or equivalent to those of the above-mentioned embodiment are referenced by identical reference signs and the description thereof will be made brief or will not be repeated. The description may be made with reference to the drawings used in the above-mentioned embodiment.

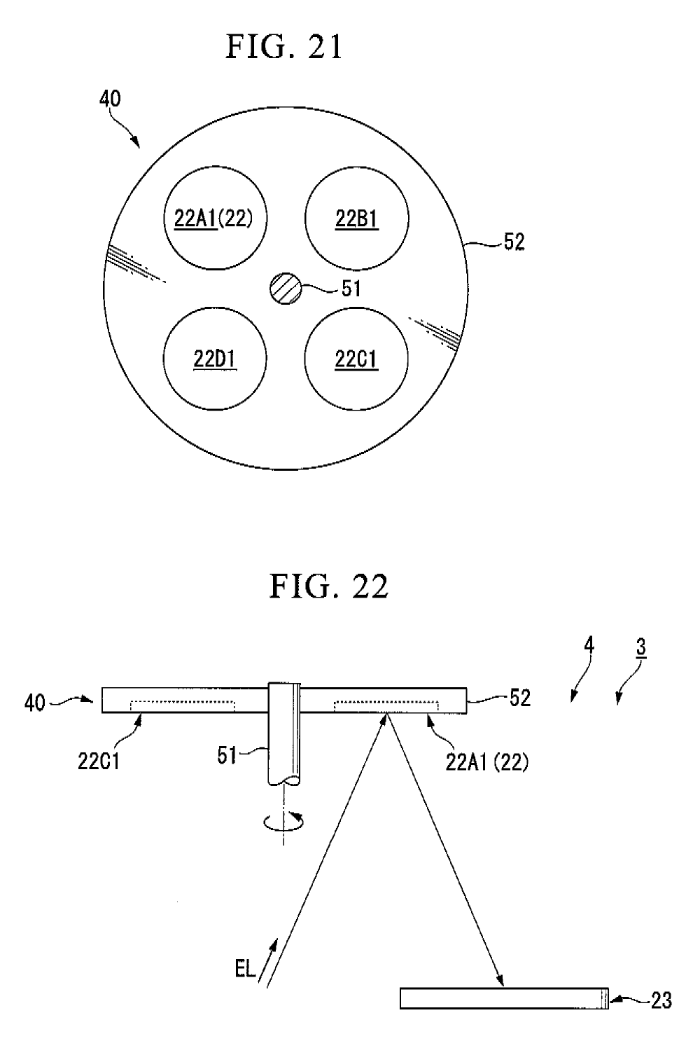

FIG. 21 is a plan view illustrating a part of an illumination device 40 according to the fourth embodiment of the invention. FIG. 22 is a diagram illustrating the configuration of an optical integrator 4 of an illumination optical apparatus 3 according to the fourth embodiment of the invention. As shown in FIG. 22, the optical integrator 4 of the fourth embodiment includes the second reflective integrator 23 of the third embodiment as a second reflective integrator 23. As shown in FIG. 21, the optical integrator 4 of the fourth embodiment includes a first reflective integrator (first reflective optical device) 22A1 having reflection characteristics corresponding to the element group (first element group) 230A1 of the second reflective integrator 23, a first reflective integrator (second reflective optical device) 22B1 having reflection characteristics corresponding to the element group (second element group) 230B1 of the second reflective integrator 23, a first reflective integrator 2201 having reflection characteristics corresponding to the element group 230C1 of the second reflective integrator 23, and a first reflective integrator 22D1 having reflection characteristics corresponding to the element group 230D1 of the second reflective integrator 23, as a first reflective integrator 22. The first reflective integrator 22A1, the first reflective integrator 22B1, the first reflective integrator 2201, and the first reflective integrator 22D1 are disposed in a turret (insertion and removal mechanism, changing mechanism) 52 which is rotatable around a rotation axis 51 extending in a predetermined direction.

The illumination optical apparatus 3 includes the illumination device 40 including the turret 52.

The illumination device 40 reflects the exposure light EL to the element group 230A1 of the second reflective integrator 23 by rotating the turret 52 and inserting the first reflective integrator 22A1 into the optical path of the exposure light EL. Accordingly, the element group 230A1 of the second reflective integrator 23 can form a secondary light source of the normal illumination as a first illumination condition (see FIG. 15).

The illumination device 40 reflects the exposure light EL to the element group 230B1 of the second reflective integrator 23 by rotating the turret 52, removing the first reflective integrator 22A1 from the optical path of the exposure light EL, and inserting the first reflective integrator 22B1 into the optical path of the exposure light EL. Accordingly, the element group 230B1 of the second reflective integrator 23 can form a secondary light source of the dipolar illumination as a second illumination condition (see FIG. 17).

The illumination device 40 reflects the exposure light EL to the element group 230C1 of the second reflective integrator 23 by rotating the turret 52, removing the first reflective integrator 22B1 from the optical path of the exposure light EL, and inserting the first reflective integrator 22C1 into the optical path of the exposure light EL. Accordingly, the element group 230C1 of the second reflective integrator 23 can form a secondary light source of the tetrapolar illumination as a third illumination condition (see FIG. 18).

The illumination device 40 reflects the exposure light EL to the element group 230D1 of the second reflective integrator 23 by rotating the turret 52, removing the first reflective integrator 22C1 from the optical path of the exposure light EL, and inserting the first reflective integrator 22D1 into the optical path of the exposure light EL. Accordingly, the element group 230D1 of the second reflective integrator 23 can form a secondary light source of the orbicular-zone illumination as a fourth illumination condition (see FIG. 19).

As described above, in the illumination optical apparatus 3 according to this embodiment, it is possible to suppress the loss in light intensity of the illumination light due to the change in illumination condition, similarly to the above-mentioned embodiment. In the illumination optical apparatus 3 according to this embodiment, it is possible to reduce the number of actuators driving the first reflective integrator, compared with the illumination optical apparatus 3 according to the above-mentioned embodiment. Accordingly, it is possible to simplify programs of the control system controlling the driving of the first reflective integrator, to reduce the burden of the control system, and to control the driving of the first reflective integrator with high accuracy.

Examples of the wafer (substrate) used in the above-mentioned embodiments include a glass substrate for a display device, a ceramic wafer for a thin-film magnetic head, and a base plate (synthetic quartz, silicon wafer) of a mask or reticle used in an exposure apparatus, in addition to a semiconductor wafer for manufacturing a semiconductor device.

The exposure apparatus having the illumination optical apparatus according to the invention can be applied to a step-and-repeat type projection exposure apparatus (stepper) that exposes a substrate with a pattern of a mask M in a bundle with the mask and the substrate stopped relative to each other and that step-like moves the substrate, in addition to the step-and-scan type scanning exposure apparatus (scanning stepper) that synchronously moves a mask and a substrate and that scans and exposes the substrate to the pattern of the mask. The invention can also be applied to a step-and-stitch type exposure apparatus that transfers at least two patterns to a substrate so as to partially overlap with each other.

For example, as disclosed in U.S. Pat. No. 6,611,316, the invention can be applied to an exposure apparatus that synthesizes patterns of two masks on a substrate through the use of a projection optical system and that substantially simultaneously double exposes one shot area on the substrate by one scanning exposure.

The type of the exposure apparatus is not limited to the exposure apparatus for manufacturing a semiconductor device, which exposes a substrate to a semiconductor device pattern, but the invention can be widely applied to exposure apparatuses for manufacturing a liquid crystal display device or a display, exposure apparatuses for manufacturing a thin-film magnetic head, an imaging device (CCD), a micro-machine, an MEMS, a DNA chip, and a reticle or mask, and the like.

It has been stated in this embodiment that EUV light is used as the exposure light EL, but, for example, bright lines (such as g-line, h-line, and i-line) emitted from mercury lamps, far-ultraviolet light (DUV light) such as KrF excimer laser light (with a wavelength of 248 nm), and vacuum ultraviolet light (VUV light) such as ArF excimer laser light (with a wavelength of 193 nm) and F2 laser light (with a wavelength of 157 nm) may be used.

The invention can be applied to a twin stage type exposure apparatus provided with plural substrate stages (wafer stages). The structure and exposing operation of the twin stage type exposure apparatus are disclosed, for example, in JP-A-10-163099, JP-A-10-214783 (corresponding to U.S. Pat. Nos. 6,341,007, 6,400,441, 6,549,269, and 6,590,634), JP-T-2000-505958 (corresponding to U.S. Pat. No. 5,969,441), and U.S. Pat. No. 6,208,407.

As described hitherto, the exposure apparatus is manufactured by combining various sub systems including various elements so as to maintain predetermined mechanical accuracy, electrical accuracy, and optical accuracy. In order to guarantee these accuracies, the adjustment of various optical systems for achieving the optical accuracy, the adjustment of various mechanical systems for achieving the mechanical accuracy, and the adjustment of various electrical systems for achieving the electrical accuracy are carried out before and after the combination. The process of combining the sub systems into an exposure apparatus includes mechanical connection between various sub systems, wiring connection in electrical circuits, and piping connection of air pressure circuits. The individual steps of assembling the respective sub steps are carried out before the process of combining various sub systems into an exposure apparatus. When the process of combining various sub systems into an exposure apparatus is ended, general adjustment is carried out and various accuracies of the exposure apparatus are guaranteed as a whole. The manufacturing of the exposure apparatus is preferably performed in a clean room of which the temperature and the degree of cleanliness are managed.

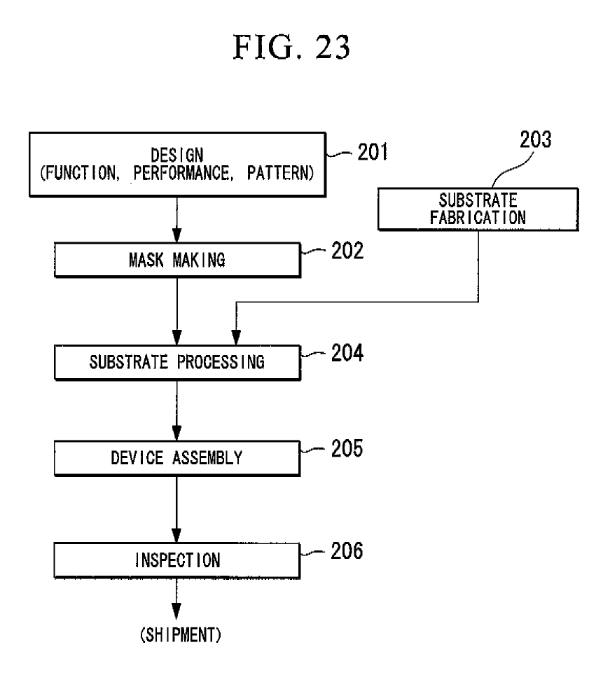

As shown in FIG. 23, a micro device such as a semiconductor device is manufactured through step 201 of designing functions and performance of the micro device, step 202 of producing a mask (reticle) based on the design step, step 203 of producing a substrate which is a base material, of the device, a substrate processing step 204 including substrate process (exposure process) such as exposing the substrate to exposure light by the use of a pattern of the mask and developing the exposed substrate as in the above-mentioned embodiments, a device assembling step (including processes such as a dicing process, a bonding process, and a packaging process) 205, and an inspection step 206.

The requirements of the above-mentioned embodiments may be appropriately combined. Some elements may not be used. As long as permitted by laws and regulations, all the publications and the disclosures of US patents related to the exposure apparatuses cited in the above-mentioned embodiments and modifications are incorporated herein by reference.

### BRIEF DESCRIPTION OF THE REFERENCE SYMBOLS

1: EXPOSURE APPARATUS
3: ILLUMINATION OPTICAL APPARATUS
4: OPTICAL INTEGRATOR
5: DRIVING UNIT (SECOND DRIVING UNIT)
22: FIRST REFLECTIVE INTEGRATOR (REFLECTIVE OPTICAL MEMBER)
22a: FIRST REFLECTIVE INTEGRATOR (SECOND REFLECTIVE OPTICAL MEMBER)
22b: FIRST REFLECTIVE INTEGRATOR (FIRST REFLECTIVE OPTICAL MEMBER)
22A1: FIRST REFLECTIVE INTEGRATOR (FIRST REFLECTIVE OPTICAL DEVICE)
22B1: FIRST REFLECTIVE INTEGRATOR (SECOND REFLECTIVE OPTICAL DEVICE)
22C1: FIRST REFLECTIVE INTEGRATOR
22D1: FIRST REFLECTIVE INTEGRATOR
23: SECOND REFLECTIVE INTEGRATOR (INTEGRATOR OPTICAL DEVICE)
40: ILLUMINATION DEVICE
52: TURRET (INSERTION AND REMOVAL MECHANISM)
220b: ELEMENT GROUP
220bA: ELEMENT GROUP (FIRST REFLECTION AREA)
220bB: ELEMENT GROUP (SECOND REFLECTION AREA)
220bC: ELEMENT GROUP
221: ELEMENT (REFLECTION ELEMENT)
221A: ELEMENT
221B: ELEMENT
221C: ELEMENT
221D: ELEMENT
221a: ELEMENT
221b: ELEMENT
221bA: ELEMENT
221bB: ELEMENT
221bC: ELEMENT
230: ELEMENT GROUP
230A: ELEMENT GROUP (FIRST ELEMENT GROUP)
230B: ELEMENT GROUP (SECOND ELEMENT GROUP)
2300: ELEMENT GROUP (THIRD ELEMENT GROUP)
230A1: ELEMENT GROUP (FIRST ELEMENT GROUP)
230A2: ELEMENT GROUP (SECOND ELEMENT GROUP)
230B1: ELEMENT GROUP (THIRD ELEMENT GROUP (SECOND ELEMENT GROUP))
230C1: ELEMENT GROUP
230D1: ELEMENT GROUP
230D2: ELEMENT GROUP
231: ELEMENT
O: PREDETERMINED AXIS
R: RETICLE (MASK)
W: WAFER
EL: EXPOSURE LIGHT (ILLUMINATION LIGHT)
PO: PROJECTION OPTICAL SYSTEM

1. An illumination optical apparatus comprising:
an integrator optical device that comprises a first element group prescribing a first illumination condition and a second element group prescribing a second illumination condition other than the first illumination condition; and
an irradiation device that selectively directs light to the first element group or the second element group.

2. The illumination optical apparatus according to claim 1, wherein the irradiation device comprises a reflective optical device that reflects the light.

3. The illumination optical apparatus according to claim 2, wherein the reflective optical device comprises:
a plurality of reflection elements each having a reflection surface; and
a driving unit that controls a least one of a slope, a position and a curvature of the reflection surface of each reflection element.

4. The illumination optical apparatus according to claim 3, wherein the driving unit independently drives the reflection surfaces of the plurality of reflection elements.

5. The illumination optical apparatus according to claim 3, wherein the driving unit controls the curvature of the reflection surface of at least one of the plurality of reflection elements.

6. The illumination optical apparatus according to claim 1, wherein the irradiation device comprises:
a first reflective optical device corresponding to the first element group;
a second reflective optical device corresponding to the second element group; and
a selection mechanism that selectively arranges the first reflective optical device or the second reflective optical device with respect to an optical path of the light.

7. The illumination optical apparatus according to claim 1, wherein the irradiation device comprises:
a first reflective optical member that comprises a first reflection area reflecting the light to the first element group and a second reflection area reflecting the light to the second element group;
a second reflective optical member that reflects the light; and
a second driving unit that drives the second reflective optical member so as to direct the light from the second reflective optical member to the first reflection or the second reflection area.

8. The illumination optical apparatus according to claim 7, wherein the second driving unit drives the second reflective optical member around a predetermined axis.

9. The illumination optical apparatus according to claim 7, wherein the second driving unit controls the curvatures of reflection surface of at least a part of the second reflective optical member.

10. The illumination optical apparatus according to claim 1, wherein the integrator optical device further comprises a third element group prescribing a third illumination condition other than the first illumination condition and the second illumination condition, and
wherein the irradiation device selectively directs the light to any of the first element group, the second element group, and the third element group.

11. The illumination optical apparatus according to claim 10, wherein some elements of the first element group, some elements of the second element group, and some elements of the third element group are commonly used for at least one condition of the first illumination condition, the second illumination condition, and the third illumination condition.

12. The illumination optical apparatus according to claim 1, wherein the first element group and the second element group are different from each other in size.

13. The illumination optical apparatus according to claim 10, wherein the size of the third element group is different from at least one of the size of the first element group and the size of the second element group.

14. An exposure apparatus comprising:
the illumination optical apparatus according to claim 1 that illuminates a mask having a pattern formed thereon; and
a projection optical system which projects a pattern image of the mask illuminated by the illumination optical apparatus onto a wafer.

15. A device manufacturing method using the exposure apparatus according to claim 14.
